(19) United States
(12) Patent Application Publication
(10) Pub. No.: US 2026/0034524 A1
(43) Pub. Date: Feb. 5, 2026

(54) EXTRUDER-MIXER

(71) Applicant: BB Engineering GmbH, Remscheid (DE)

(72) Inventors: Friedel Dickmeiss, Langenfeld (DE); Wolfgang Imping, Remscheid (DE); Nils Stary, Wuppertal (DE); Ludger Reichling, Wermelskirchen (DE)

(21) Appl. No.: 19/099,633

(22) PCT Filed: Aug. 2, 2023
(86) PCT No.: PCT/EP2023/071427

§ 371 Date: Jan. 29, 2025

(30) Foreign Application Priority Data
Aug. 4, 2022 (DE) 10 2022 119 630.5

(51) Int. Cl. B01F 27/272; B01F 27/1143; B01F 27/13; B01F 27/192; B01F 35/32; B01F 101/00

(52) U.S. Cl. CPC B01F 27/2722; B01F 27/1143; B01F 27/13; B01F 27/192; B01F 35/324; B01F 2101/2805

(57) ABSTRACT

An extruder-mixer has a stator and a rotor which is arranged coaxially with respect to the stator. The rotor is rotatably supported with respect to the stator. The stator is at least partially arranged inside a volume defined by the rotor. The rotor has a rotor cage having a large number of apertures. The apertures are configured to be elongate in a longitudinal direction and the longitudinal direction thereof extends in each case in a skewed manner with respect to a rotation axis of the rotor.

The present invention relates to an extruder-mixer having a stator and a rotor which is arranged coaxially with respect to the stator, wherein the rotor is rotatably supported with respect to the stator.

Extruder-mixers of the type mentioned in the introduction are in principle known from the prior art and are typically used for mixing viscous and partially filled fluids and molten polymers.

An apparatus for mixing plastifiable plastic resins is disclosed in the Utility Model specification DE 7433808 U.

The European Patent Application EP 0 048 590 B1 describes an extruder-mixer having a hollow-cylindrical stator and a cylindrical rotor which is supported within the stator for the rotation thereof. The cylindrical surfaces of the rotor and the stator which are directed toward each other each carry large numbers of parallel rows of cavities which extend over a circumference.

An extruder-mixer having an extruder screw comprising at least one sleeve and a cylindrical screw tip which is supported therein is disclosed in the German Patent Application DE 10 2007 022 287 A1.

An object of the present invention is to provide an alternative extruder-mixer.

An extruder-mixer is an apparatus which is configured specifically for use in an extruder and which serves to mix material which is intended to be extruded. Not every apparatus which is suitable for mixing a fluid can therefore be interpreted to be an extruder-mixer.

The extruder-mixer has a rotor and a stator. The rotor can be rotated relative to the stator. The stator is not rotatable in so far as the stator cannot be rotated during normal use of the extruder-mixer. This may, for example, be the case as a result of the fact that the stator is fixedly mounted. No further element is preferably arranged between the rotor and stator.

The object is achieved in that the stator is at least partially arranged inside a volume defined by the rotor. It has been found to be advantageous for the stator, with respect to its stator length in an axial direction, to be arranged predominantly inside the rotor.

The extruder-mixer according to the invention forms the basis for extruders having a high mixing power with little structural space. Furthermore, it has been found that an extruder-mixer in which the stator is arranged at least partially inside a volume defined by the rotor can be retrofitted in a comparatively simple manner in existing extruders. In addition, there is produced a possible variability as a result of a simple axial positioning of the stator. A decisive additional advantage of the extruder-mixer according to the invention is the possibility of being able to introduce an additive or a plurality of additives into an inner volume of the rotor through the stator.

The invention includes the recognition that, with all extruder-mixers of the prior art, the rotor is rotatably arranged inside the stator. In a departure from this technical prejudice, in the extruder-mixer according to the invention the stator is at least partially arranged inside a volume defined by the rotor. It has been found to be advantageous for a predominant length of the stator to be arranged inside the volume defined by the rotor.

In a particularly preferred embodiment, the stator has at least one in particular elongate recess and the rotor has at least one in particular elongate aperture. In another particularly preferred configuration, the recess and the aperture are arranged in such a manner that the recess and the aperture at least partially overlap during operation of the extruder-mixer. Preferably, the stator has a large number of recesses and/or the rotor has a large number of apertures. Preferably, the recesses cover at least 30%, in particular at least 50% or even at least 80% of a covering face of the stator. Preferably, the apertures cover at least 30%, in particular at least 50% or even at least 80% of a covering face of the rotor. As a result of the recesses and apertures, the fluid can be mixed particularly well.

In another particularly preferred embodiment, the rotor has a rotor cage. It has been found to be advantageous for the stator to have an axial bore via which a fluid can be introduced into the rotor. It has been found to be advantageous for the stator, with respect to the stator length thereof in an axial direction, to be arranged predominantly inside the rotor cage. A rotor cage intended to be understood to be a grid structure which is formed by means of grid struts and apertures which are formed therebetween.

In a particularly preferred embodiment, the rotor has a plurality of apertures. The aperture or the apertures may in each case be provided as a hole or slot. In a particularly preferred embodiment, the apertures of the rotor are arranged in a plurality of aperture rows. It has been found to be advantageous for the aperture rows to extend in each case in a longitudinal direction (axial direction) of the rotor, in particular parallel with a rotation axis of the rotor. In another particularly preferred embodiment, the aperture rows are arranged on the rotor in a state uniformly spaced apart from each other along a circumference of the rotor. It has been found to be advantageous for the apertures to be configured to be elongate in a longitudinal direction and for the longitudinal direction thereof to extend in each case parallel with a rotation axis of the rotor. Alternatively, the longitudinal direction of the apertures may extend in each case in a skewed manner with respect to the rotation axis of the rotor.

The recesses in the stator are configured to be elongate in a longitudinal direction. The longitudinal direction of the recesses extends in each case in a skewed manner with respect to the rotation axis of the rotor. The longitudinal direction of an aperture may be parallel with a longitudinal direction of a recess. The longitudinal direction of an aperture may be skewed or crossed with respect to a longitudinal direction of a recess.

In another particularly preferred embodiment, the stator has a large number of recesses. In a particularly preferred embodiment, the recesses of the stator are arranged in a plurality of recess rows. It has been found to be advantageous for the recess rows to extend in each case in the longitudinal direction of the stator, in particular parallel with the rotation axis of the rotor. In another particularly preferred embodiment, the recess rows are arranged on the stator in a state uniformly spaced apart from each other along a circumference of the rotor. It has been found to be advantageous for the longitudinal portion of the stator on which the plurality of recesses which are involved in the mixing operation are formed to be arranged predominantly, preferably at least at a rate of 50 percent, more preferably at least 80 percent, inside the rotor and/or the rotor cage.

It has been found to be advantageous for an aperture of the rotor to be positioned in each case offset centrally with respect to a corresponding recess of the stator. A central offset may be relative to the circumferential direction and/or the longitudinal direction of the stator. As a result of the size and the number of recesses in the stator and the size and the number of apertures in the rotor and the axial positioning of the rotor and stator with respect to each other, a variation of the mixing action (by changing the overlap of the inlet/outlet coverings) is achieved. Consequently, for example, by replacing the stator the mixing power of the extruder-mixer can be influenced significantly. The arrangement of the apertures of the rotor and the corresponding recesses in the stator is preferably selected in rows and/or with a central offset of preferably 50% of a row unit. As a result of an axial displacement of the stator relative to the rotor, the offset (overlap) can be varied (10-50%/90-50%).

In another particularly preferred embodiment, the apertures of the rotor are arranged in an axially offset or helical arrangement. It has been found to be advantageous for the apertures of the rotor to be introduced in a single-turn or multiple-turn helix and for the apertures to preferably correspond to the recesses of the stator. It has been found to be advantageous for the recesses of the stator to be introduced into a single-turn or multiple-turn helix.

In another particularly preferred embodiment, the apertures in the rotor and/or the corresponding recesses in the stator are in the form of a spherical cap, partially circular disk and/or channel groove.

In a particularly preferred embodiment, the number of recesses in the stator is different from the number of apertures in the rotor. It has been found to be advantageous for the number of apertures in the rotor to be at least 1 more than the number of the corresponding recesses in the stator.

It has been found to be advantageous for a width of the apertures in the rotor and/or a width of the corresponding recesses in the stator to be preferably from 5 to 35 mm. A width of the apertures and the recesses is determined in the circumferential direction of the rotor or stator. A length of the apertures in the rotor and/or a length of the corresponding recesses in the stator is preferably a large number, preferably a factor of from 2 to 5 of the respective width of the aperture and/or the recess. In another particularly preferred embodiment, a maximum depth of the recess in the stator, with respect to a radial direction of the stator, is preferably from 5 to 15 mm. It has been found to be advantageous with respect to a rheological optimization for the radii of the apertures and/or the radii of the recesses to be selected to be proportional with respect to the respective widths. In a particularly preferred embodiment, a radius is more than 2 mm.

It has been found to be advantageous for the apertures of the rotor and/or the recesses of the stator, in each case with respect to the longitudinal direction thereof, to extend parallel with the rotation axis of the rotor. Alternatively, the apertures of the rotor and/or the recesses of the stator, in each case with respect to the longitudinal direction thereof, extend in each case in an angled manner with respect to the rotation axis of the rotor. It has been found to be advantageous for such an angle to be fixed in the range from −45° to +45° with respect to the rotation axis.

The invention is also achieved with an extruder having an extruder-mixer of the type described above and having an extruder screw which is supported in a screw housing of the extruder and which is coupled to a worm drive of the extruder. The extruder according to the invention can be further developed by the features described in relation to the extruder-mixer in a corresponding manner. It has been found to be advantageous for the rotor to be arranged at least partially inside a volume defined by the screw housing. It has been found to be advantageous for the rotor, with respect to its rotor length in an axial direction, to be arranged predominantly inside the screw housing. In a particularly preferred embodiment, the stator, the rotor and the screw housing are arranged coaxially with respect to each other.

In a particularly preferred embodiment, the worm drive is coupled in terms of rotation to the rotor of the extruder-mixer. In other words, a rotation of the worm drive preferably results in a rotation of the rotor of the extruder-mixer.

In another particularly preferred embodiment, the extruder has an extruder head. It has been found to be advantageous for the screw housing to be flange-mounted on the extruder head. In a particularly preferred embodiment, the stator of the extruder-mixer is arranged in a rotationally secure manner with respect to the extruder head. The stator may be screwed to the extruder head. It has been found to be advantageous for the extruder screw to be configured integrally with the rotor. In another particularly preferred embodiment, the worm drive is arranged at a side, facing away from the extruder head, of the screw housing. In another particularly preferred embodiment, the extruder has a rotor drive which can be operated independently of the worm drive. It has been found to be advantageous for the rotor drive to be coupled in terms of rotation to the rotor of the extruder-mixer. It has been found to be advantageous for the worm drive to be arranged at the side of the screw housing. Alternatively, the worm drive may be arranged at the side of the rotor of the extruder-mixer.

Other advantages will be appreciated from the following description of the Figures. In the Figures, various exemplary embodiments of the present invention are illustrated. The Figures, the description and the claims contain numerous features in combination. The person skilled in the art will advantageously also consider the features individually and combine them to form other advantageous combinations. In the Figures, identical and equivalent components are given the same reference numerals. In the drawings:

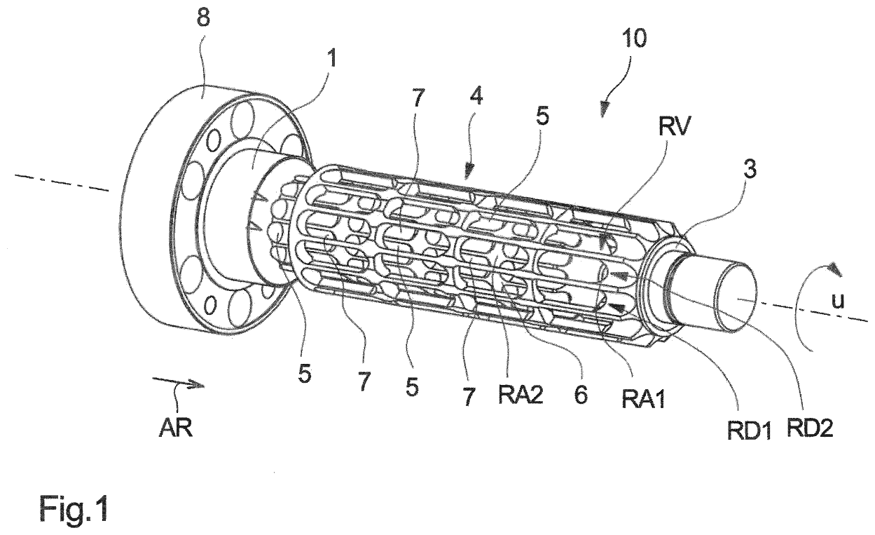

FIG. 1 shows a first preferred exemplary embodiment of an extruder-mixer;

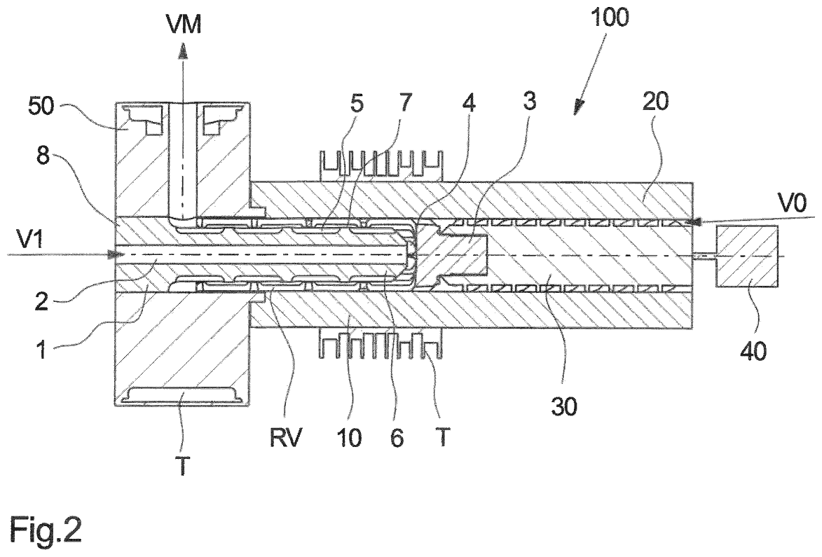

FIG. 2 shows a first preferred exemplary embodiment of an extruder;

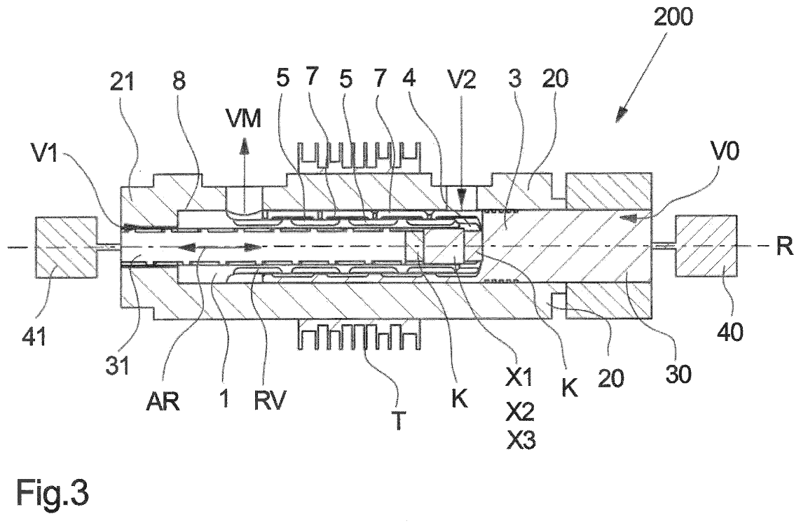

FIG. 3 shows a second preferred exemplary embodiment of an extruder; and

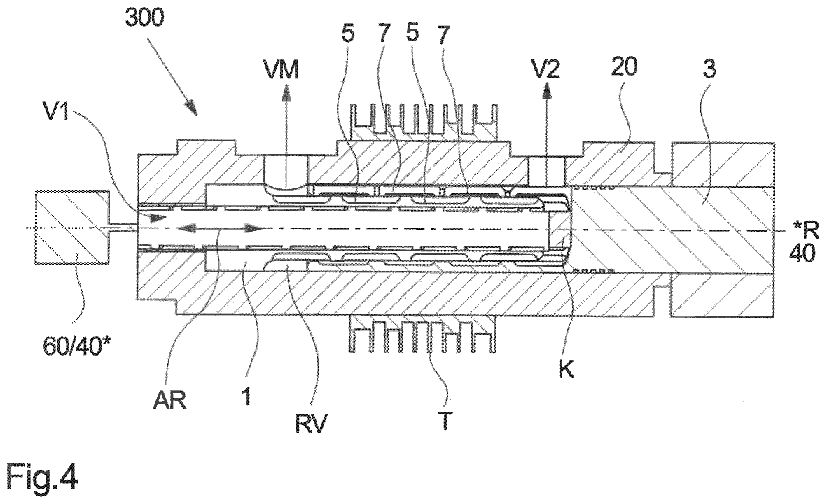

FIG. 4 shows a third preferred exemplary embodiment of an extruder;

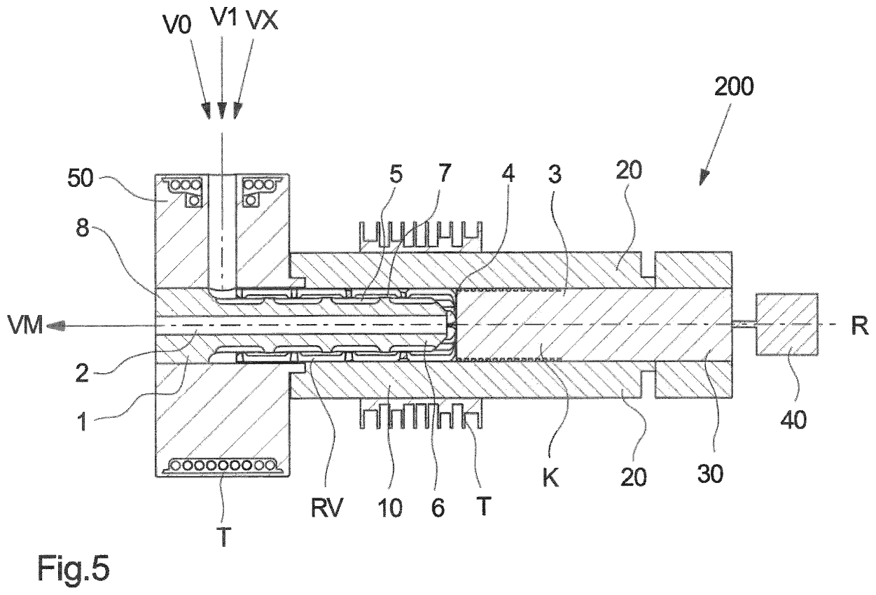

FIG. 5 shows a preferred exemplary embodiment of an extruder according to the invention;

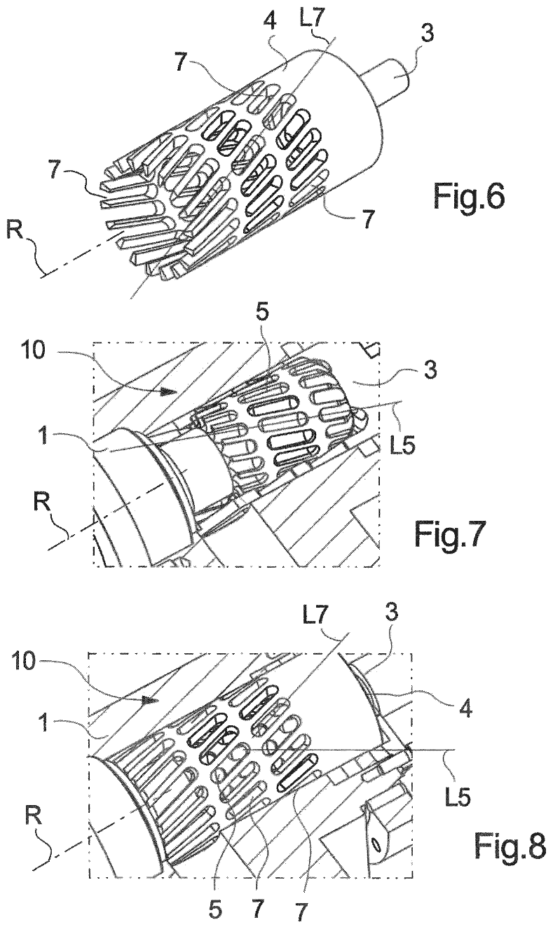

FIG. 6 shows a preferred exemplary embodiment of a rotor cage;

FIG. 7 shows a preferred exemplary embodiment of a stator; and

FIG. 8 shows an assembly of the rotor cage of FIG. 6 with the stator of FIG. 7.

A first preferred exemplary embodiment of an extruder-mixer 10 is illustrated in FIG. 1. The extruder-mixer 10 is provided with a stator 1 and a rotor 3 which is arranged coaxially with respect to the stator 1. The rotor 3 is rotatably supported relative to the stator 3. During operation, the rotor 3 rotates about the rotation axis R. The stator 1 has a plurality of recesses 5 and the rotor 3 has a plurality of apertures 7. At least one recess 5 overlaps with at least one aperture 7.

The stator 1 is arranged at least partially inside a volume RV defined by the rotor 3. As can be seen in FIG. 1, a stator shaft 6 of the stator 3 is located predominantly, with respect to the axial direction AR, within a rotor cage 4 of the rotor 3. A stator shaft 6 is in particular intended to be understood to be the region of the stator 3 on which the plurality of recesses 5 are formed. The stator 3 comprises the stator shaft 6 and a stator head 8 which is formed integrally with the stator 6. A rotor cage 4 is in particular intended to be understood to be the region of the rotor 3 on which the plurality of apertures 7 are formed.

As can also be seen in FIG. 1, the apertures 7 of the rotor 3 are arranged in a plurality of aperture rows RD1, RD2, etcetera. The aperture rows RD1, RD2 extend in each case in an axial direction AR and are arranged spaced apart from each other in a uniform manner on the rotor 3 along a circumference U of the rotor 3. The recesses 5 of the stator 1 are arranged in a plurality of recess rows RA1, RA2, etcetera. The recess rows RA1, RA2 extend in each case in an axial direction AR and are arranged spaced apart from each other in a uniform manner on the stator 1 along a circumference of the stator 1.

The stator 1 also has an axial bore 2 (cf. also FIG. 2) via which a fluid can be introduced into the rotor 3.

A first exemplary embodiment of an extruder 100 is illustrated in FIG. 2. The extruder 100 has an extruder-mixer 10 according to the exemplary embodiment of FIG. 1.

As can be seen in FIG. 2, the extruder 100 is provided with an extruder screw 30 which is supported in a screw housing 20 of the extruder 100. The extruder screw 30 is coupled to a worm drive 40 of the extruder 100 so that the extruder screw 30 can be caused to rotate about the rotation axis R. The screw drive 40 is arranged at a side, facing away from the extruder head 50, of the screw housing 20.

The extruder 100 has an extruder head 50, wherein the screw housing 30 is flange-mounted on the extruder head 50. The stator head 8 of the stator 1 of the extruder-mixer 10 is screwed to the extruder head 50 and is consequently arranged in a rotationally secure manner with respect to the extruder head 50. The term “extruder head” includes as a term the fact that this component is positioned with the described functions at the head end of an extruder and preferably receives measuring devices for physically describing the extruded fluid/polymer (for example, pressure and temperature sensors).

The worm drive 30 is itself coupled in terms of rotation to the rotor 3 of the extruder-mixer 10 so that the rotor 3 can be caused to rotate about the rotation axis R. In the exemplary embodiment illustrated in this instance, the extruder screw 30 is coupled in terms of rotation to the rotor 3 of the extruder-mixer 10 so that the worm drive 40 drives both the extruder screw 30 and the rotor 3 in rotation.

It is possible to clearly see in FIG. 2 the axial bore 2 which extends coaxially with respect to the rotation axis R within the stator 1. Via the axial bore 2, a fluid, for example, a color component, can be introduced into the rotor 3.

The extruder head 50 receives a single-component or multiple-component stator 1 centrally. This stator 1 integrates the functions of a fixed stator head 8, the axial bore 2 (or where applicable also a plurality of holes) for the connection and the supply of the components to be mixed in the mixing space which is formed by the rotor 3. In the stator shaft 6 of the bore(s) in the form of an outlet region, mechanically or hydraulically controlled installations for temporarily closing and/or throttling the supplied fluid may be provided. The fluid flow which is discharged from the axial bore 2 is pressed into the central centric mixer cavity which is positioned on the head and from there distributed uniformly in a radial manner over the circumference and the first apertures 4. The stator 1 in the region of the extruder head 8 additionally contains the described recesses 5 (stator cavities) which are arranged so as to correspond to the apertures 7 (rotor apertures) of the rotor 3. Both the extruder head 50 and the filling piece 1 are provided with holes for receiving sensors. The heating can be carried out both via fluid media and via contact and convection heating systems. The correct operation enables counter-clockwise rotation and clockwise rotation of the rotor 3 and the connected extruder screw 30 about the central stator 1. The stator 1 may in turn be joined together from a plurality of components which preferably enables the simple variation/replacement of the recesses 5 (mixer cavities).

A second exemplary embodiment of an extruder 200 is illustrated in FIG. 3. The extruder 200 has an extruder-mixer 10 according to the exemplary embodiment of FIG. 1. The extruder 200 is provided with an extruder screw 30 which is supported in a screw housing 20 of the extruder 200. The extruder screw 30 is coupled to a worm drive 40 of the extruder 200 so that the extruder screw 30 can be caused to rotate about the rotation axis R. In contrast to the exemplary embodiment of FIG. 2, with the extruder 200 of FIG. 3 the separate or extended screw housing 21, with the extruder screw 31 and the additional worm drive 41—which together can be referred to as a feed unit—are arranged at a side, facing away from the rotor 3, within the stator head 8.

As can be seen in FIG. 3, the extruder 200 has a second drive 41 which can be operated independently of the worm drive 40 (or rotor drive 60). The drive 41 is coupled in terms of rotation to an extruder screw 31 which rotates in a temperature-controllable cylinder which is separately flange-mounted or configured integrally with the cylinder of the extruder-mixer 100, and conveys a fluid or produces polymer melts. This second drive 41 is—with respect to the stator head 8—arranged opposite the worm drive 40 (or rotor drive 60) and uses both the cylinder 21 and the stator 8 as a surrounding cylinder. In the outlet region of the stator head 6, on the rotating extruder screw 31 either a mechanically or hydraulically operating functional unit X is positioned or by means of corresponding shaping of the outlet region and the axial positionability of the rotating extruder screw 31 a throttle action and/or closure of the outlet is possible. The temperature control of the cylinders 20 and 21 can be carried out both by means of fluid media and by contact and convection heating systems (and combinations). The correct operation enables the anti-clockwise and clockwise rotation of the connected screw 21 in the central filling piece 8 which additionally the cavities described (stator cavities) 5 which are arranged so as to correspond to the apertures of the rotor 7 (rotor apertures).

The mechanically or hydraulically operating functional unit X which is positioned in the outlet region of the stator shaft 6 may alternatively be coupled to the worm drive 40 (or rotor drive 60). The special forms of the functional unit X are in the form of a throttle unit X, blocking unit X2 or volume pump X3.

A third exemplary embodiment of an extruder 300 is illustrated in FIG. 4. The extruder 300 has an extruder-mixer 10 according to the exemplary embodiment of FIG. 1. As in the exemplary embodiment of FIG. 3, with the extruder 300 of FIG. 4 the screw housing 20, the extruder screw 30 and the worm drive 40—which can be referred to together as a feed unit—are arranged at the side, facing away from the rotor 3, of the stator head 8.

In contrast to the exemplary embodiment of FIG. 3, the extruder 100 of FIG. 4 has only one drive in the form of the worm drive 40. The worm drive 40 is arranged at the side of the screw housing 20. Alternatively, in place of the worm drive 40, a rotor drive 60 can be arranged at the side of the rotor 3 of the extruder-mixer 10.

A rotational coupling of the worm drive 40 with the rotor 3 of the extruder-mixer 10 is achieved by means of a coupling rod which extends coaxially with respect to the rotation axis R through the stator 1.

The correct operation is achieved by means of the supply of volume flows of different polymers and/or fluids via the screw conveying system and/or feed holes in the extruder-mixer. FIG. 2 shows the minimum case of the polymer provision via a screw VO and the pressure feed of the second volume flow V1 in the extruder-mixer 10. An outlet hole discharges the mixture as a volume flow VM out of the extruder-mixer 10. The number of pressure feeds of additional volume flows VX is not limited.

The illustration in FIG. 3 shows the correct operation via the supply of two volume flows V0, V1 via the separately driven screws/rotors and the pressure feed of a third volume flow V2 in the extruder-mixer 10. An outlet hole discharges the mixture as a volume flow VM from the extruder-mixer 10. The number of pressure feeds of additional volume flows VX is not limited.

The illustration in FIG. 4 shows the correct operation via the supply of volume flow VI via the screws/rotors which are driven in a coupled manner and the pressure feed of a second volume flow V2 in the extruder-mixer 10. An outlet hole discharges the mixture as a volume flow VM from the extruder-mixer 10. The number of pressure feeds of additional volume flows VX is not limited.

A fourth exemplary embodiment of an extruder 200 according to the invention is illustrated in FIG. 5. The exemplary embodiment of FIG. 5 is structurally similar to the exemplary embodiment of FIG. 2 with the difference that during correct operation of the extruder 200 of FIG. 5 no supply of a volume flow V0 is carried out and can be carried out at the worm drive. During correct operation, the supply of the volume flows during correct operation is carried out by supplying the volume flows V0, V1 and VX into the extruder head 50, that is to say, perpendicularly to the rotation axis R of the rotor 3. The volume flow VM (volume flow “mixture”) is discharged during correct operation through the axial bore 2 out of the stator 1.

FIG. 6 shows a preferred exemplary embodiment of the rotor 3 which has a rotor cage 4 having a large number of apertures 7. In contrast to the exemplary embodiments of FIGS. 1 to 5, in which the apertures 7 are configured to be elongate in a longitudinal direction and the longitudinal direction thereof extends in each case parallel with a rotation axis R of the rotor 3, the apertures 7 do not extend in the longitudinal direction L7 thereof parallel with the rotation axis R of the rotor 3.

FIG. 7 shows a preferred exemplary embodiment of a stator 1 which has a large number of recesses 5. In contrast to the exemplary embodiments of FIGS. 1 to 5 in which the recesses are configured to be elongate in a longitudinal direction and the longitudinal direction thereof extends in each case parallel with a rotation axis R of the rotor 3, the recesses 5 do not extend in the longitudinal direction L5 thereof parallel with the rotation axis R of the rotor 3 (not illustrated here).

FIG. 8 finally shows an extruder-mixer as an assembly of the rotor 3 of FIG. 6 with the stator 1 of FIG. 7. As can be seen in FIG. 8, the longitudinal direction L7 of the apertures 7 does not extend parallel with the longitudinal direction L5 of the recesses 5. The mixing behavior of the extruder-mixer can thereby be influenced in a positive manner.

### LIST OF REFERENCE NUMERALS

1 Stator
2 Axial bore
3 Rotor
4 Rotor cage
5 Recess
6 Stator shaft
7 Aperture
8 Stator head
10 Extruder-mixer
20 Screw housing
21 Screw housing
30 Extruder screw
31 Extruder screw
40 Worm drive
41 Worm drive
50 Extruder head
60 Rotor drive
100 Extruder with extruder-mixer
200 Extruder/mixer in independent state
300 Extruder/mixer in coupled state
AR Axial direction
L5 Longitudinal direction of recess
L7 Longitudinal direction of aperture
R Rotation axis
RA Recess row
RD Aperture row
RV Rotor volume
T Temperature control
U Circumference
K Coupling
X Functional unit (can be coupled)
X1 Functional unit for throttling
X2 Functional unit for blocking
X3 Functional unit for pumping
V0 Volume flow “0”
V1 Volume flow “1”
V2 Volume flow “2”
VX Volume flow “X”
VM Volume flow “Mixture”

1. An extruder-mixer having a stator and a rotor which is arranged coaxially with respect to the stator, wherein the rotor is rotatably supported with respect to the stator, wherein the stator is at least partially arranged inside a volume (RV) defined by the rotor,
wherein the rotor has a rotor cage having a large number of apertures, wherein the apertures are configured to be elongate in a longitudinal direction and the longitudinal direction thereof extends in each case in a skewed manner with respect to a rotation axis of the rotor.

2. The extruder-mixer as claimed in claim 1, wherein the stator has at least one recess and the rotor has at least one aperture, wherein the recess and the aperture at least partially overlap during operation of the extruder-mixer.

3. The extruder-mixer as claimed in claim 1,
wherein the stator has an axial bore via which a fluid can be introduced into the rotor.

4. An extruder having an extruder-mixer,
wherein the extruder-mixer having a stator and a rotor which is arranged coaxially relative to the stator, wherein the rotor is rotatably supported relative to the stator, wherein the stator is arranged at least partially inside a volume (RV) defined by the rotor, and the rotor has a rotor cage having a large number of apertures, wherein the apertures are configured to be elongate in a longitudinal direction and the longitudinal direction thereof extends in each case in a skewed manner with respect to a rotation axis of the rotor and having
an extruder screw which is supported in a screw housing of the extruder which is coupled to a worm drive of the extruder.

5. The extruder as claimed in claim 4, wherein the stator has at least one recess and the rotor has at least one aperture, wherein the recess and the aperture at least partially overlap during operation of the extruder-mixer.

6. The extruder as claimed in claim 4,
wherein the extruder has an extruder head, wherein the screw housing is flange-mounted on the extruder head and the stator of the extruder-mixer is arranged in a rotationally secure manner with respect to the extruder head.

7. The extruder as claimed in claim 6, characterized in that wherein the extruder screw is configured integrally with the rotor.

8. The extruder as claimed in claim 7, wherein the worm drive is arranged at a side, facing away from the extruder head, of the screw housing.

9. The extruder as claimed in claim 8,
wherein the worm drive is arranged at the side of the screw housing.

10. The extruder as claimed in claim 4,
wherein the worm drive is arranged at a side of the rotors of the extruder-mixer.

11. The extruder as claimed in claim 4, wherein the extruder has a rotor drive which can be operated independently of the worm drive, wherein the rotor drive is rotationally coupled to the rotor of the extruder-mixer.

12. The extruder as claimed in claim 9, wherein the worm drive of an extruder or a separate rotor drive is rotationally coupled to the rotor of the extruder-mixer and inside the stator head another worm drive having an extruder screw functions centrally with respect to the rotation axis.

13. The extruder as claimed in claim 9, wherein the worm drive having the worm drive functions centrally with respect to the rotation axis and can be positioned in an axial direction.

14. The extruder as claimed in claim 9, wherein either the worm drive of an extruder or a separate rotor drive is coupled to a functional unit inside the stator.

15. The extruder as claimed in claim 12, wherein the functional unit has inside the stator the function of a throttle.

16. The extruder as claimed in claim 12, wherein the functional unit has inside the stator the function of a blocking device.

17. The extruder as claimed in claim 12, wherein the functional unit has inside the stator the function of a volume pump.

18. An extruder having an extruder-mixer having a stator and a rotor which is arranged coaxially relative to the stator, wherein the rotor is rotatably supported relative to the stator, wherein the stator is arranged at least partially inside a volume (RV) defined by the rotor, wherein the rotor has a rotor cage having a large number of apertures, wherein the apertures are configured to be elongate in a longitudinal direction and the longitudinal direction thereof extends in each case in a skewed manner with respect to a rotation axis of the rotor and having an extruder screw which is supported in a screw housing of the extruder which is coupled to a worm drive of the extruder, and wherein the extruder has an extruder head having a supply through which volume flows are supplied to the extruder.

19. The extruder as claimed in claim 18, wherein the supply is configured perpendicularly to a rotation axis of the rotor.

20. The extruder as claimed in claim 4, wherein the rotor and the extruder screw are rotationally coupled.

21. The extruder as claimed in claim 20, wherein the extruder has positioned the worm drive at one of the two ends of the rotationally coupled unit.
